(19) United States
(12) Patent Application Publication
(10) Pub. No.: US 2019/0304002 A1
(43) Pub. Date: Oct. 3, 2019

(54) VIDEO MONITORING AND ANALYSIS TO ASSESS PRODUCT PREFERENCES OF A USER

(71) Applicant: International Business Machines Corporation, Armonk, NY (US)

(72) Inventors: Siddique M. Adoni, St. Thomas Town (IN); Dhandapani Shanmugam, HAL Post (IN); Jayashree Kumar, Bangalore (IN); Yethish Venkataramanachari, Robertsonpet (IN)

(21) Appl. No.: 16/447,097

(22) Filed: Jun. 20, 2019

Related U.S. Application Data
(63) Continuation of application No. 15/923,007, filed on Mar. 16, 2018.

(51) Int. Cl. G06Q 30/06

(52) U.S. Cl. CPC G06Q 30/0631; G06K 9/00771

(57) ABSTRACT

A computer system monitors a user to assess product preferences. A video from an image capture device monitoring a user is analyzed. An image is selected from the video of the user for image processing, wherein the user is visible in the frame. The selected image is processed to determine one or more products used by the user. One or more product recommendations are determined based on the one or more products used by the user. Embodiments of the present invention further include a method and program product for assessing product preferences for a user in substantially the same manner described above.

### BACKGROUND

### 1. Technical Field

Present invention embodiments relate to video monitoring and image processing, and more specifically, to assessing a consumer's preferences for products by analyzing video of the consumer, and making recommendations to the consumer based on the assessment.

### 2. Discussion of the Related Art

Targeted advertising refers to the use of advertisements that are tailored toward a particular audience in order to more effectively reach consumers. Online retailers use many methods to serve consumers with targeted advertisements based on the product or service being sold and the consumers that are being targeted. Advertisements may be targeted according to demographic data and based on consumers' behaviors, such as purchase history, browser history, and other recent activity. In order to increase sales, retailers are constantly looking for better ways to target advertisements and to reach consumers.

### SUMMARY

According to one embodiment of the present invention, a computer system monitors a user to assess product preferences. A video from an image capture device monitoring a user is analyzed. An image is selected from the video of the user for image processing, wherein the user is visible in the frame. The selected image is processed to determine one or more products used by the user. One or more product recommendations are determined based on the one or more products used by the user. Embodiments of the present invention further include a method and program product for processing requests for health information in substantially the same manner described above.

### BRIEF DESCRIPTION OF THE DRAWINGS

Generally, like reference numerals in the various figures are utilized to designate like components.

FIG. 1 is a block diagram depicting a computing environment for assessing a user's product preferences in accordance with an embodiment of the present invention;

FIG. 2 is a flow chart depicting a method of recommending products in accordance with an embodiment of the present invention;

FIGS. 3A and 3B illustrate examples of a user device in accordance with an embodiment of the present invention; and

FIG. 4 is a block diagram depicting a computing device in accordance with an embodiment of the present invention.

### DETAILED DESCRIPTION

Present invention embodiments relate generally to video monitoring and image processing, and more specifically, to assessing a user's preferences for products by analyzing video of the user, and making recommendations or targeted advertisements to the user based on the assessment. Traditional online advertising approaches may analyze a user's web activity, including purchase history and browsing history. However, an individual's purchase history can give a false impression, as the individual may be buying items on behalf of others (e.g. as gifts). Similarly, an individual's browsing history can be misleading; for example, multiple users may share devices, or a user may not be entirely honest when completing an online survey. An individual's preference for apparel or other products may be more accurately determined by observing what the individual actually wears or uses. Present invention embodiments capture video of a user, analyze the video to determine what apparel or other products the user is wearing or using, and make recommendations that are targeted to the user.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of embodiments of the invention as set forth hereinafter.

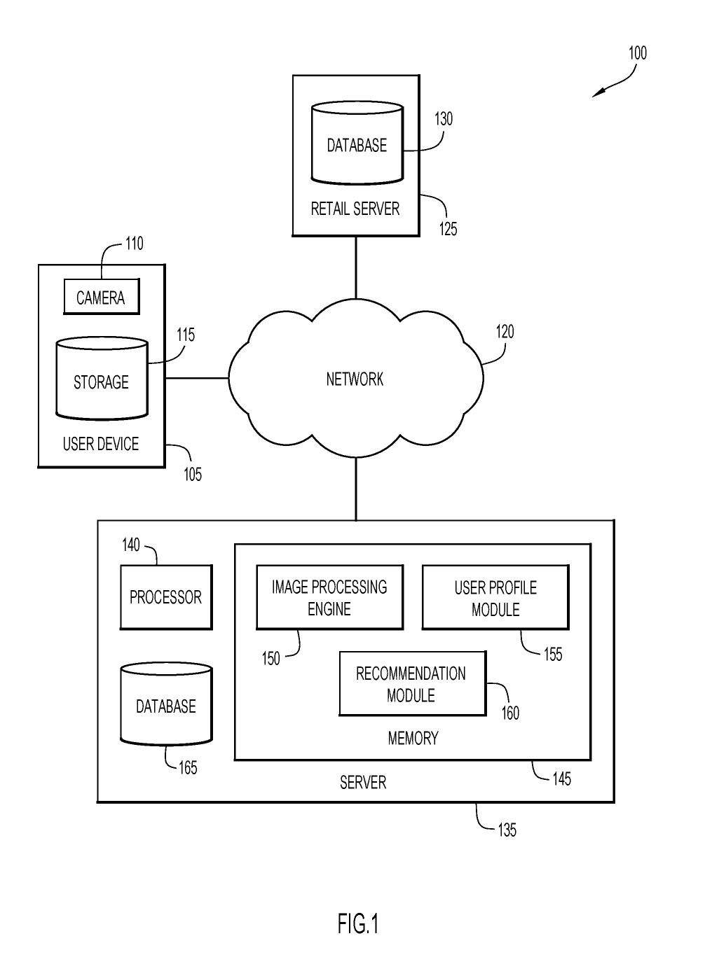

Present invention embodiments will now be described in detail with reference to the Figures. FIG. 1 is a block diagram depicting a computing environment 100 for assessing a user's product preferences in accordance with an embodiment of the present invention. As depicted, computing environment 100 includes a user device 105, network 120, an electronic commerce server 125, and a server 135.

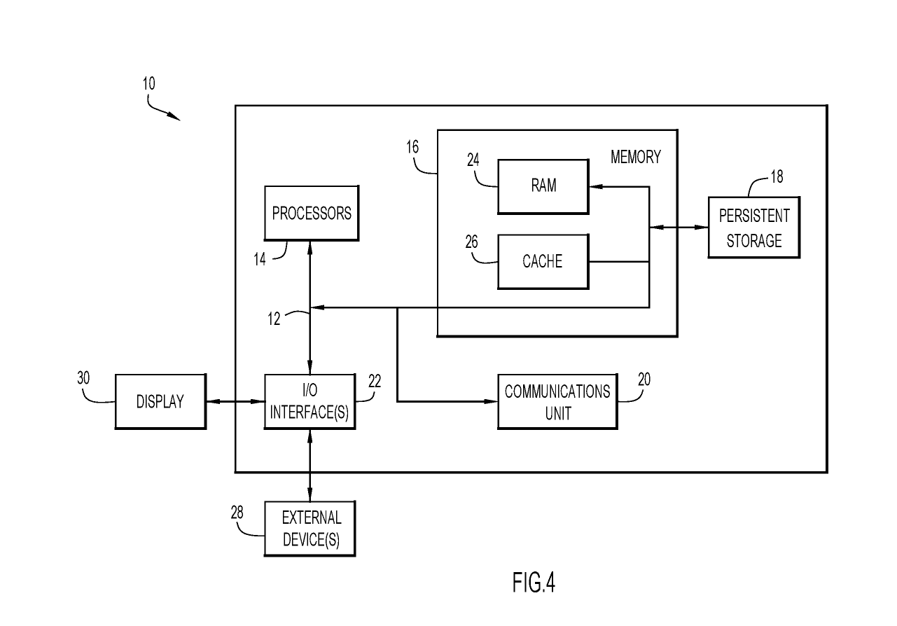

User device 105 may include a laptop computer, a tablet computer, a netbook computer, a personal computer (PC), a desktop computer, a personal digital assistant (PDA), a smart phone, a thin client, or any programmable electronic device capable of executing computer readable program instructions. User device 105 includes a camera 110 and storage 115. Camera 110 may be any conventional or other image capture device, and may be used to take photographs, record video, and to facilitate video conferences. In some embodiments, user device 105 is a smartphone or tablet, and camera 110 is a front-facing camera. User device 105 may include internal and external hardware components, as depicted and described in further detail with respect to FIG. 4.

Storage 115 may include any non-volatile storage media known in the art. For example, storage 115 can be implemented with flash memory, a tape library, optical library, one or more independent hard disk drives, or multiple hard disk drives in a redundant array of independent disks (RAID). Similarly, data on storage 115 may conform to any suitable storage architecture known in the art, such as a file, a relational database, an object-oriented database, and/or one or more tables. Storage 115 may store video and images captured with camera 110.

Network 120 may include a local area network (LAN), a wide area network (WAN) such as the Internet, or a combination of the two, and include wired, wireless, or fiber optic connections. In general, network 120 can be any combination of connections and protocols that will support communications between user device 105, electronic commerce server 125, and server 135 in accordance with embodiments of the present invention.

Electronic commerce server 125 may include a database 130, and be implemented by any server that supports electronic commerce. Users may access electronic commerce server 125 using a web browser in order to browse through items and make purchases. In some embodiments, electronic commerce server 125 provides promotions and indicates whether items are on sale or are going to be discounted in the future.

Database 130 may include any non-volatile storage media known in the art. For example, database 130 can be implemented with flash memory, a tape library, optical library, one or more independent hard disk drives, or multiple hard disk drives in a redundant array of independent disks (RAID). Similarly, data on database 130 may conform to any suitable storage architecture known in the art, such as a file, a relational database, an object-oriented database, and/or one or more tables. Database 130 may store a listing of items that are sold by the vendor operating electronic commerce server 125, along with images of items, prices of items, shipping fees for items, indications of whether a given item is in stock, and the like.

Generally, server 135 may determine a user's preferences for apparel and other products and make recommendations to the user. Server 135 includes a processor 140, database 165, memory 145, image processing engine 150, user profile module 155, and recommendation module 160. Image processing engine 150 may process video and/or images of a user acquired using camera 110 of user device 105 in order to determine which apparel or product item(s) the user is wearing or using. User profile module 155 may create and/or update a profile for a user that tracks the user's apparel or product preferences. Recommendation module 160 may make recommendations to a user based on the apparel or product preferences. Image processing engine 150, user profile module 155, and recommendation module 160 may reside in memory 145 and use processor 140 to carry out aspects of the present invention.

Image processing engine 150 may receive one or more pictures and/or video of a user that was taken with camera 110. In some embodiments, a user of user device 105 opts to share a video stream from their camera 110 with server 135. For example, a user may, during a video conference with another, select an option that enables real-time sharing of video captured by camera 110 with image processing engine 150. Image processing engine 150 may retrieve video of the user that was recorded previously (e.g. via camera 110) and is stored in storage 115.

Image processing engine 150 may analyze a video on a frame-by-frame basis to select a subset of one or more images based on how clearly the user is represented in the frames. For example, image processing engine 150 may preferentially select one or more frames in which a user (or a portion of a user) is prominently visible instead of frames in which a user's back is turned, the lighting is poor, the user has stepped out of the field of view of camera 110, etc. This may be performed by various conventional or other image processing techniques.

Image processing engine 150 may perform various conventional or other image processing techniques on the selected subset of frames. In some embodiments, image processing engine 150 deblurs images, adjusts image contrast, saturation, hue, and the like. Image processing engine 150 may identify products, such as apparel items that a user is wearing, in the selected subset of images. Image processing engine 150 may identify products using machine learning techniques. Image processing engine 150 may employ various models to perform the learning (e.g., neural networks, mathematical/statistical models, classifiers, etc.). Image processing engine 150 may be trained using supervised or unsupervised learning. Thus, image processing engine 150 may be trained to identify any sort of apparel or product worn or used by a user, such as shirts, jackets, pants, shorts, skirts, scarves, hats, vests, and any other apparel or product used or worn.

In some embodiments, image processing engine 150 identifies apparel items or products by assigning an occupancy percentage and confidence percentage to elements of the apparel or product. The occupancy percentage may refer to the percent of a frame (or apparel item or product within a frame) that is occupied by a given element (such as a logo). The confidence percentage may refer to the degree of confidence that image processing engine 150 has correctly identified an apparel item or product, or attribute thereof. For example, when image processing engine 150 is applied to an image of a user wearing a blue t-shirt that has white stripes and a black logo, image processing engine 150 may determine that 70% of the shirt is occupied by a blue material with 90% confidence, that 23% of the shirt is occupied by a white material with 90% confidence, and that 7% of the shirt is occupied by a black logo with 95% confidence.

Image processing engine 150 may also determine the fabric or material of an apparel item. In some embodiments, image processing engine 150 is trained with sample images of a variety of different types of fabrics in order to determine a confidence percentage with regard to fabric/material for various apparel items. Image processing engine 150 may be trained to identify brand identifiers, as well as cosmetics or ornaments, such as lipstick, nail paint shades, hair style, hair color, hair products, eye shadow shades, piercings, earrings, eyeglasses, sunglasses, bangles, rings, watches, and any other apparel, tattoos, cosmetic item, ornament, and/or product worn on one's person or used by a person.

In some embodiments, image processing engine 150 uses location and time information received from user device 105 to supplement the machine learning analysis in order to improve confidence. For example, if a user is located in a warm climate when a picture is taken, it is more probable that the user is wearing a cotton shirt instead of a wool shirt. Time information may also help image processing engine 150 refine what a user is wearing, since a user may be inclined to wear more formal apparel at certain times of the day, or on weekdays versus weekends, etc. The location of a user may be determined according to their user device 105. Metadata associated with video retrieved from camera 110 may indicate the time and place in which the user was imaged. Image processing engine 150 may reference a user's electronic calendar to improve a confidence score about the apparel or products worn by a user. For example, if a user may tend to wear certain apparel or use certain products depending on whether the user's scheduled event is a party, a business meeting, a wedding, a vacation, etc.

User profile module 155 may create, modify, and maintain a profile for each user that tracks a user's apparel or product preferences. User profile module 155 may receive information from image processing engine 150 about a user's apparel or product preferences, such as the brands, designs, types, colors, and materials that a user tends to use. User profile module 155 may store user profile information in database 165. In some embodiments, user profile module 155 updates a user's profile information each time a user's image is processed by image processing engine 150.

Recommendation module 160 may determine apparel or product recommendations for a user based on the user's preferences. In some embodiments, recommendation module 160 consults a user's profile information stored in database 165 or consults user profile module 155 to determine apparel or product recommendations in which a user is likely to be interested. Recommendation module 160 may apply a variety of statistical analyses using a user's profile information to find correlations between the user's preferences that may indicate certain apparel or product recommendations to which the user may be receptive. For example, if the user tends to wear a certain color, pattern, material, or style frequently, recommendation module 160 may recommend apparel in the same color, pattern, material, or style, or apparel that matches it. If a user tends to wear certain brands, recommendation module 160 may recommend apparel or products made by the same or a similar manufacturer. Similarly, if a user tends to wear items having certain designs, recommendation module 160 may recommend apparel or products having similar designs. Recommendation module 160 may also make recommendations based on a user's previous purchase history; for example, if a user has already purchased a particular apparel or product item, recommendation module 160 may not recommend it.

Recommendation module 160 may connect to an electronic commerce server, such as electronic commerce server 125, to find specific items to recommend to a user. In some embodiments, recommendation module 160 sends a hyperlink to user device 105 that points to an apparel or product item for sale on electronic commerce server 125. Recommendation module 160 may also send recommendations to a third party to be used for marketing or for serving targeted advertisements to users.

Database 165 may include any non-volatile storage media known in the art. For example, database 165 can be implemented with flash memory, a tape library, optical library, one or more independent hard disk drives, or multiple hard disk drives in a redundant array of independent disks (RAID). Similarly, data on database 165 may conform to any suitable storage architecture known in the art, such as a file, a relational database, an object-oriented database, and/or one or more tables. Database 165 may store information about a user's apparel or product preferences, a user's browsing history, purchase history, recommendation history, and history of purchases based on previous recommendations.

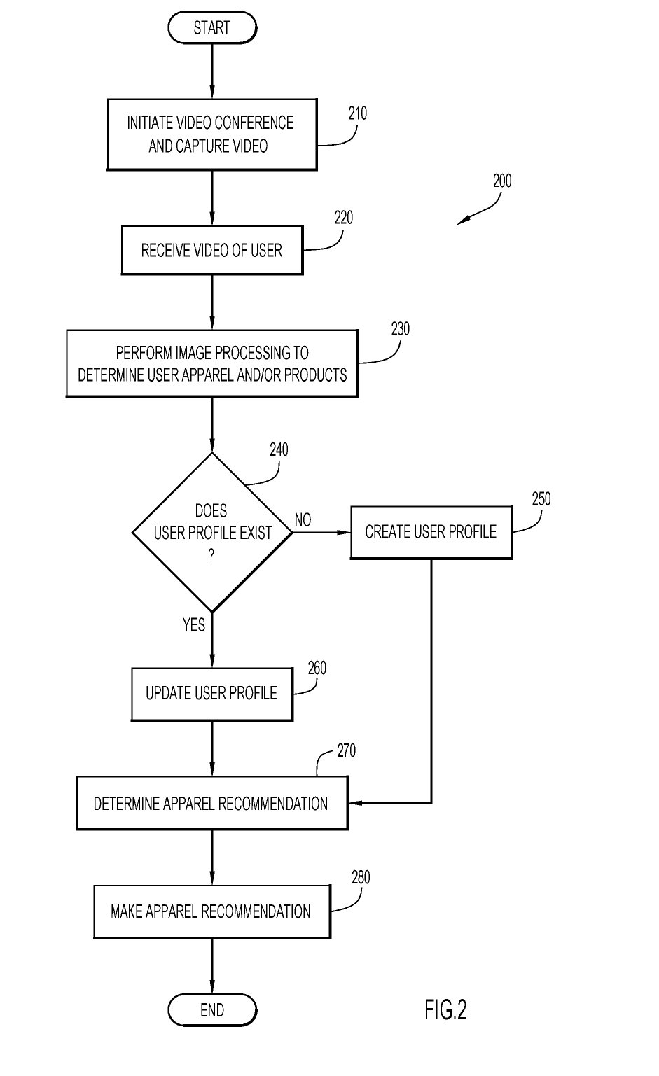

FIG. 2 is a flow chart depicting a method 200 of recommending apparel or other products in accordance with an embodiment of the present invention.

A video conference is initiated and video is captured at operation 210. In some embodiments, a user may begin a video conference by calling one or more recipient, who may accept or decline the video conference call. Upon accepting the call, a connection is established between the user's device and each of the recipients' devices. The participants may communicate with each other in sound and vision that is captured by a microphone and camera respectively of a device (such as user device 110).

A video of a user is received at operation 220. In some embodiments, a user participating in a video conference on user device 105 may share the real-time video stream with server 135. For example, a user may receive a message or notification during a video conference asking for the user's permission to share the video stream with server 135. In some embodiments, a video conference or other video of a user may be retrieved from storage 115.

Image processing is performed to determine the apparel or products that the user is wearing or using at operation 230. One or more still frames or images may be extracted from the video stream for processing based on how clearly the user is represented in the images. For example, image processing engine 150 may preferentially select one or more frames in which a user (or a portion of a user) is prominently visible instead of frames in which a user's back is turned, the lighting is poor, the user has stepped out of the field of view of camera 110, etc. Machine learning may be employed to determine the apparel items that the user is wearing, including the color, fabric, and brand of apparel items. This may be performed by various conventional or other image processing techniques.

Operation 240 determines whether a user profile already exists for the user. If a user profile already exists, method 200 proceeds to operation 260. If a user profile does not exist, method 200 proceeds to create a user profile at operation 250. A user profile may include any information regarding the apparel items or products that a user has worn when imaged by camera 110, including the color, fabric, and brand of apparel items or products, the confidence percentage for each item, the frequency at which the user wears or uses the same (or similar) apparel items or products, and any other information of interest regarding the user's product preferences. If a user already has a profile, then method 200 proceeds to operation 260 to update the user's profile. Thus, on each occasion that a user shares a video stream or saved video with server 135, their user profile may be updated. User profile module 155 may create and update profiles according to input from image processing engine 150.

An apparel or product recommendation is determined at operation 270. In some embodiments, recommendation module 160 determines a recommendation based on a user's product preferences as summarized in their user profile. Recommendation module 160 may also access electronic commerce server 125 in order to cross-reference apparel items or products that are currently on sale with items that the user may prefer. For example, if a user tends to wear shirts made by a particular designer, and similar shirts by the same designer are on sale by the retailer operating electronic commerce server 125, then recommendation module 160 may determine that those similar shirts should be recommended to the user. One or more electronic commerce servers, such as electronic commerce server 125, may be accessed using an API, by crawling retail websites, servers and/or databases, or by otherwise indexing retail websites, servers, and/or databases.

The apparel or product recommendation is made to the user at operation 280. A user may receive the recommendation when they are browsing a web page as an advertisement, or may receive the recommendation via e-mail, text message, or application notification. In some embodiments, the recommendation is not made directly to a user by server 125 but is instead shared with a third party, who in turn uses the recommendation to serve targeted advertisements to the user.

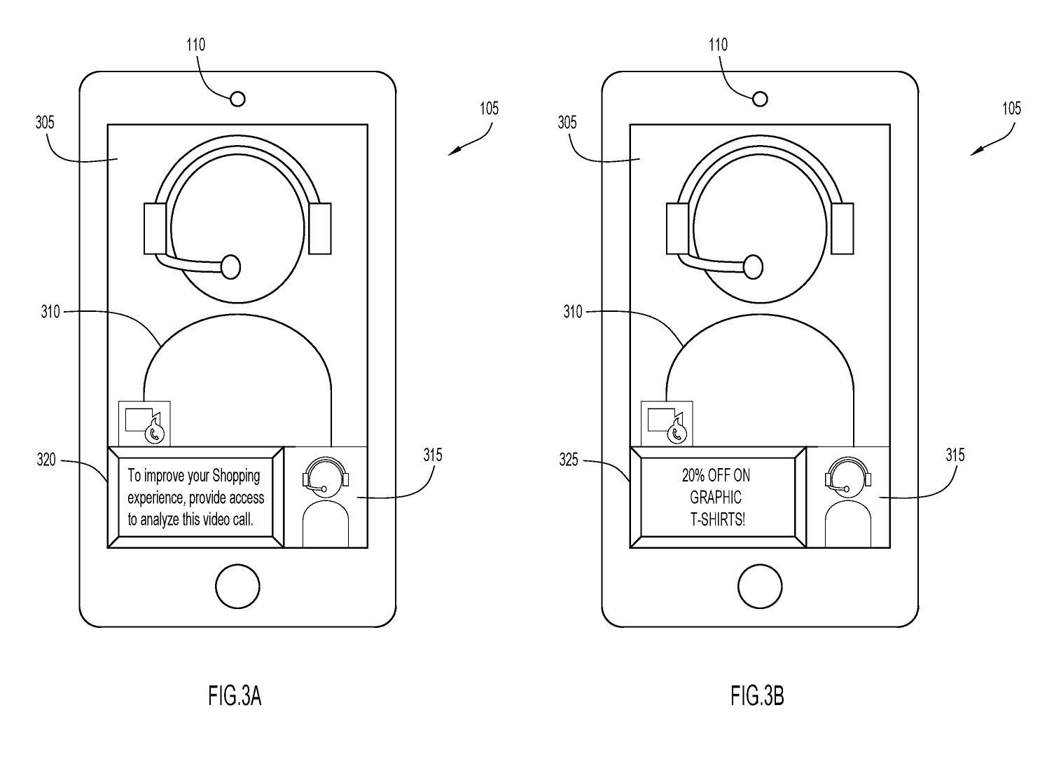

FIGS. 3A and 3B illustrate examples of a user device 105 in accordance with an embodiment of the present invention. As depicted, user device 105 includes camera 110, and a display 305, including a conference pane 310, user pane 315, a dialog box 320, and a recommendation box 325.

Display 305 may show user interface elements, such as a conference pane 310, a user pane 315, a dialog box 320, and a recommendation box 325, during a video conference between a user of user device 110 and a conference participant. Conference pane 310 may display a view of the conference participant as captured by the participant's camera (e.g., on a participant's remote device), and user pane 315 may display a view of the user of user device 110 as captured by camera 110.

During a telephone conference, a user may share their video stream so that the user's apparel or products may be analyzed and recommendations may be made accordingly. FIG. 3A depicts a user being prompted by a user display element, such as dialog box 320, to begin sharing the video stream. Once a user elects to share the video stream, their apparel product may be analyzed to determine the user's apparel or product preferences according to present invention embodiments. FIG. 3B depicts a recommendation (e.g., “20% off on graphic t-shirts!”) being delivered to user device 110 via recommendation box 325.

FIG. 4 is a block diagram depicting components of a computer 10 suitable for executing the methods disclosed herein. Computer 10 may enable user device 105, electronic commerce server 125, and server 135 to assess product preferences of a user in accordance with embodiments of the present invention. It should be appreciated that FIG. 4 provides only an illustration of one embodiment and does not imply any limitations with regard to the environments in which different embodiments may be implemented. Many modifications to the depicted environment may be made.

As depicted, the computer 10 includes communications fabric 12, which provides communications between computer processor(s) 14, memory 16, persistent storage 18, communications unit 20, and input/output (I/O) interface(s) 22. Processor(s) 14 and memory 16 may be substantially similar to processor 140 and memory 145 of FIG. 1, and persistent storage 18 may be substantially similar to storage 115, database 130, and database 165 of FIG. 1. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Memory 16 and persistent storage 18 are computer readable storage media. In the depicted embodiment, memory 16 includes random access memory (RAM) 24 and cache memory 26. In general, memory 16 can include any suitable volatile or non-volatile computer readable storage media.

One or more programs may be stored in persistent storage 18 for execution by one or more of the respective computer processors 14 via one or more memories of memory 16. The persistent storage 18 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Communications unit 20, in these examples, provides for communications with other data processing systems or devices. In these examples, communications unit 20 includes one or more network interface cards. Communications unit 20 may provide communications through the use of either or both physical and wireless communications links.

I/O interface(s) 22 allows for input and output of data with other devices that may be connected to computer 10. For example, I/O interface 22 may provide a connection to external devices 28 such as a keyboard, keypad, a touch screen, and/or some other suitable input device. External devices 28 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 18 via I/O interface(s) 22. I/O interface(s) 22 may also connect to a display 30. Display 30 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Data, such as video data, user product preference data, and product recommendation data, may be stored within any conventional or other data structures (e.g., files, arrays, lists, stacks, queues, records, etc.) and may be stored in any desired storage unit (e.g., database, data or other repositories, queue, etc.). The data transmitted between user device 105, electronic commerce server 125, and server 135 may include any desired format and arrangement, and may include any quantity of any types of fields of any size to store the data. The definition and data model for any of video data, user product preference data, and/or product recommendation data may indicate the overall structure in any desired fashion (e.g., computer-related languages, graphical representation, listing, etc.).

Data, such as video data, user product preference data, and product recommendation data, may include any information provided by user device 105, database 130, and database 165. Data, such as video data, user product preference data, and product recommendation data may include any desired format and arrangement, and may include any quantity of any types of fields of any size to store any desired data. The fields may indicate the presence, absence, actual values, or any other desired characteristics of the data of interest (e.g., quantity, value ranges, etc.). Data, such as video data, user product preference data, and product recommendation data, may include all or any desired portion (e.g., any quantity of specific fields) of personal information (PI) or other data of interest within a given implementation or system. Data, such as video data, user product preference data, and product recommendation data, may indicate the overall structure in any desired fashion (e.g., computer-related languages, graphical representation, listing, etc.). The fields and/or tables for the data stored in a database, such as database 130 or database 165, may be selected automatically (e.g., based on metadata, common or pre-defined models or structures, etc.) or manually (e.g., pre-defined, supplied by a data owner or electronic commerce vendor, etc.) in any desired fashion for a particular implementation or system. Metadata (e.g., for types or categories of products and/or apparel, etc.) may include any suitable information providing a description of fields or information (e.g., description of content, data type, etc.).

The data, such as video data, user product preference data, and product recommendation data, may include any data collected about entities by any collection means, any combination of collected information, any information derived from analyzing collected information.

The present invention embodiments may employ any number of any type of user interface (e.g., Graphical User Interface (GUI), command-line, prompt, etc.) for obtaining or providing information (e.g., video data, user product preference data, and product recommendation data), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for generation and analysis of various types of data, even in the absence of that data. For example, present invention embodiments may be utilized for any types of data interest (e.g, sensitive data (personal information (PI) including information pertaining to patients, customers, suppliers, citizens, and/or employees, etc.) non-sensitive data, data that may become unavailable (e.g., data that is subject to deletion after retention for a minimum time interval (e.g., information subject to various regulations, etc.), information that becomes unavailable due to system outage, power failure, or other data loss, etc.), etc.). Further, present invention embodiments may generate and utilize any quantity of data regarding entities of interest.

It will be appreciated that the embodiments described above and illustrated in the drawings represent only a few of the many ways of implementing embodiments for assessing user product and apparel preferences.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, video teleconference software, image processing engine 150, user profile module 155, recommendation module 160, etc.). These systems may include any types of monitors and input devices (e.g., keyboard, mouse, voice recognition, etc.) to enter and/or view information.

It is to be understood that the software (e.g., browser software, communications software, server software, video teleconference software, image processing engine 150, user profile module 155, recommendation module 160, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., browser software, communications software, server software, video teleconference software, image processing engine 150, user profile module 155, recommendation module 160, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., video data, user product preference data, and product recommendation data). The database system may be implemented by any number of any conventional or other databases, data stores or storage structures (e.g., files, databases, data structures, data or other repositories, etc.) to store information (e.g., video data, user product preference data, and product recommendation data). The database system may be included within or coupled to the server and/or client systems. The database systems and/or storage structures may be remote from or local to the computer or other processing systems, and may store any desired data (e.g., video data, user product preference data, and product recommendation data).

The present invention embodiments may employ any number of any type of user interface (e.g., Graphical User Interface (GUI), command-line, prompt, etc.) for obtaining or providing information (e.g., video data, user product preference data, and product recommendation data), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for monitoring a user to assess product preferences, the method comprising:
analyzing a video from an image capture device monitoring a user;
selecting an image from the video of the user for image processing, wherein the user is visible in the selected frame;
processing the selected image to determine one or more products used by the user; and
determining one or more product recommendations based on the one or more products used by the user.

2. The computer-implemented method of claim 1, further comprising sending the one or more product recommendations to a user device of the user.

3. The computer-implemented method of claim 1, further comprising sending the one or more product recommendations to a third party.

4. The computer-implemented method of claim 1, further comprising updating a user profile of the user with the one or more products used by the user, wherein the user profile comprises a history of products used by the user.

5. The computer-implemented method of claim 4, wherein determining the one or more product recommendations further comprises determining the one or more product recommendations based on the history of products used by the user.

6. The computer-implemented method of claim 1, wherein determining the one or more product recommendations further comprises accessing an electronic commerce database comprising a plurality of products being vended, and selecting a subset of the plurality of products being vended to include in the one or more product recommendations.

7. The computer-implemented method of claim 1, wherein the one or more product recommendations comprises one or more products offered by an electronic commerce merchant at a discount.
